(19) United States
(12) Patent Application Publication
(10) Pub. No.: US 2002/0177982 A1
(43) Pub. Date: Nov. 28, 2002

(54) Virtual showroom for designing a lighting plan

(75) Inventors: Mourad Boulouednine, Munich (DE); Thomas Hasslberger, Ruhpolding (DE); Michael Reithmeier, Eichenau (DE); Martin Reuter, Munich (DE)

Correspondence Address: COHEN, PONTANI, LIEBERMAN & PAVANE, 551 FIFTH AVENUE, SUITE 1210, NEW YORK, NY, 10176, US

(73) Assignee: Patent-Treuhand-Gesellschaft fur elektriche Gluhlampen m.b.H.

(21) Appl. No.: 10/100,972

(22) Filed: Mar. 19, 2002

Related U.S. Application Data
(60) Provisional application No. 60/277,070, filed on Mar. 19, 2001.

(51) Int. Cl. G06F 17/50

(52) U.S. Cl. 703/1; 703/13; 700/17

(57) ABSTRACT

Design by a consumer of a lighting plan for illuminating a space is facilitated. An electronic display is provided of a room showing a plurality of areas thereof. Selection by the consumer of any one from among the plurality of areas is enabled, and then selection by the consumer of any one from among a plurality of lighting arrangements available for illuminating the selected area is enabled. The consumer is enabled to repeat the area selection and lighting arrangement selection for all of the plurality of areas. The room is displayed as illuminated by the combined effect of illuminating all of the plurality of areas with the lighting arrangements respectively selected therefor, so that the overall effect of the combination of lighting arrangements in all the areas of the room is simulated as realistically as possible. The consumer can thus find the best overall lighting plan.

### CROSS REFERENCE TO RELATED APPLICATION

This application claims the benefit of U.S. Provisional Application No. 60/277,070 filed Mar. 19, 2001.

### FIELD OF THE INVENTION

The present invention is directed to a technique for selecting a lighting arrangement for illuminating a particular room and, in particular, for assisting consumers to make such lighting selections by presenting a computerized simulation of the room as it is illuminated by the selected lighting arrangement.

### BACKGROUND OF THE INVENTION

Consumers may be interested in selecting new lighting, in making improvements to existing lighting, in special lighting situations, or in light in general. Often this involves a specific physical space for which the lighting, or illumination, is desired. Illuminating a space requires selection of luminaries (i.e. bulbs) and fixtures, and their placement. The planning, or design, should take into consideration various factors such as the shape of the space, its furnishings and the activities to be carried out in it. This is not a simple process, and consumers typically have to guess or to use a trial and error approach for achieving the kind of lighting they prefer. In an effort to assist consumers in this task, sellers of lighting products have relied on printed brochures with pictures of illuminated rooms, and have even set up showrooms that are furnished and illuminated with different lighting products. However, the use of printed brochures and setting up such showrooms have various drawbacks. For practical reasons of cost and space, brochures and showrooms can serve to demonstrate only a very limited number of different types of areas (e.g. kitchen, living room) and alternative lighting solutions. Also, the furnished showrooms are quite expensive and are either exposed only to people living in their vicinity or, if presented at fair for lighting equipment, exist for a very brief period of time.

### SUMMARY OF THE INVENTION

One object of the present invention is to facilitate the process of designing a lighting plan for illuminating a particular space.

Another object of the present invention is to enable consumers to readily set up their own simulated individual lighting arrangements.

Yet another object of the present invention is to enable consumers to study the simulated effect of different lighting arrangements.

A further object of the present invention is to provide a virtual showroom where consumers can view the effects of different lighting arrangements from many different perspectives.

Still another object of the present invention is to enable consumers to readily simulate lighting arrangements in various rooms and to test their effect.

It is also an object of the present invention to provide pertinent product information to consumers which is readily accessible during simulation of different lighting arrangements and the comparison of their effect.

Another object of the present invention is to give consumers a simple-to-use tool for comparing several lighting solutions for one room, and to make a personal decision as to which provides the best illumination effect for the consumer's application.

These and other objects are attained in accordance with one aspect of the invention directed to a computerized method to facilitate design by a consumer of a lighting plan for illuminating a room. An electronic display is provided of a room showing a plurality of areas thereof. Selection by the consumer of any one from among the plurality of areas is enabled, and then selection by the consumer of any one from among a plurality of lighting arrangements available for illuminating the selected area is enabled. The consumer is enabled to repeat the area selection and lighting arrangement selection until a lighting arrangement has been selected for all of the plurality of areas. The plurality of areas are then displayed, respectively illuminated by the selected lighting arrangements, so that the consumer can decide whether the selected lighting arrangements, constituting the lighting plan for the room, are satisfactory.

Another aspect of the present invention is directed to an apparatus for effecting the above-described method.

One other aspect of the present invention is directed to an article of manufacture for use in a computer system and having a computer readable code means for effecting the above-described method.

Yet another aspect of the present invention is directed to a computer data signal embodied in a carrier wave, for use to facilitate design by a consumer of a lighting plan for illuminating a room, comprising a first code segment for providing an electronic display of a room showing a plurality of areas thereof, a second code segment for enabling selection by the consumer of any one from among the plurality of areas, a third code segment for enabling selection by the consumer of any one from among a plurality of lighting arrangements available for illuminating the selected area, a fourth code segment for enabling the consumer to repeat the area selection and lighting arrangement selection until a lighting arrangement has been selected for all of the plurality of areas, and a fifth code segment for displaying the plurality of areas respectively illuminated by the selected lighting arrangements, so that the consumer can decide whether the selected lighting arrangements, constituting the lighting plan for the room, are satisfactory.

### BRIEF DESCRIPTION OF THE DRAWINGS

FIGS. 1A and 1B, when combined, show a flowchart of operations performed in accordance with the invention.

FIG. 2 recreates a computer screen showing a panoramic view juxtaposed with a plan view for a selected room.

FIG. 3 recreates a computer screen showing the available lighting arrangements juxtaposed with a perspective view of a selected area lit by the selected lighting arrangement.

### DETAILED DESCRIPTION OF THE DRAWINGS

It is contemplated that the invention will be implemented with a computerized system that would typically include a personal computer, a keyboard and/or a mouse, a monitor, and one or more speakers. The operating system is preferably WINDOWS or Mac OS, and a browser such as Internet Explorer or Netscape Navigator is used. In particular, the invention has been developed for the latest generations of internet browsers (i.e. versions 4.0 and higher) and some operations require “Shockwave” as a plug-in (available from Macromedia) for the browser. This plug-in is already included in Internet Explorer 5.0. Some data storage capacity on a computer-readable medium is useful. A computer-readable medium is any article of manufacture that contains data which can be read by a computer, or a carrier wave signal carrying data that can be read by a computer. For example, code corresponding to the computer program and/or databases to enable execution of the various required computerized operations in accordance with the invention may be stored and distributed on magnetic media, such as floppy disk, flexible disk, hard disk, reel-to-reel tape, cartridge tape and cassette tape; optical media, such as CD-ROM and writable compact disk; and paper media, such as punched cards and paper tape; memory chips such as a RAM, a PROM, an EPROM, a FLASH-EPROM; or on a carrier wave signal received through a network, wireless network, or modem, including radio-frequency signals and infrared signals.

The term “consumers” as used herein refers to architects, lighting planners, electrical planners, electricians, wholesalers, homeowners, business owners and anyone else involved with lighting design and/or the purchase of lighting products.

The term “room” as used herein refers to any space which is illuminated with electrically-powered lighting, such space being interior to or exterior of a private residence, a commercial building or an industrial building, for example.

The term “lighting arrangement” as used herein refers to a luminary (i.e. a source of electrically-powered light, such as a bulb) with and/or without a fixture (i.e. a housing for the bulb to, for example, simply hold the bulb or to also affect the light in terms of spread and intensity).

The preferred embodiment of the invention is implemented as relying on communication over the Internet and is aimed at conveniently helping consumers to develop ideas for illuminating homes or offices, for example. Thus, although the implementation of the invention can take various other forms, as pointed out above, the following discussion will focus on using the Internet, although it is to be understood that this is being done without in any way intending to limit the scope of the invention to this approach.

Before proceeding to describe the detailed implementation of the invention, an overview of what features are made available to the consumer and how these can be used is presented.

The computerized system is utilized to present the consumer with an electronic display of a simulated room having suitable furnishings and illuminated by a lighting arrangement. This is referred to herein as a virtual showroom feature (also referred to herein for convenience just by the term “virtual showroom” or just “room”). The virtual showroom feature provides a choice of ten different rooms, including a living room, kitchen, bathroom and bedroom. The invention enables the consumer to “step into” any of these rooms and then try out different lighting arrangements.

There are 27 different lighting arrangement options in each room. Three different lighting arrangements can be selected for each of three different areas in the room, and these can then also be combined with each other. In the ten rooms there are therefore 270 different ways of designing, experiencing and understanding light.

By simply clicking on one of the room choices, the following screen contents appear:

1. a rotating 360° panoramic view of the selected room, and

2. a plan view which corresponds to the panoramic view of the room, with three different areas being identified thereon.

When the invention displays the panoramic view (used interchangeably herein with “panorama”) of the selected room, the orientation and size of this view can be controlled with the mouse, for example, as if it were controlling a video camera. If the kitchen is selected, for example, the panorama rotates sequentially to three different areas, such as a working area (e.g. a counter), an eating area (e.g. a breakfast nook) and a storage area (e.g. a pantry).

By clicking on one of the areas in the plan view, the corresponding perspective view thereof is shown in a new display which at first appears as a dark, not illuminated view of the selected area. Adjacent the darkened area, three proposed lighting arrangements are shown. When one of the lighting arrangements is selected, a picture of the bulb is displayed along with a controller, which is an on/off switch or a dimmer.

The consumer can switch on or dim the light for the displayed area by means of the controller to view its effect on that area. To get comparisons, the consumer can do this with each of the three different lighting arrangements. Then, to view the effect of the selected lighting for the entire room, the lighting arrangements selected for all three areas in it can be combined in the rotating panoramic view by clicking on a button labeled “panoramic view”.

By using the panorama for panning around the room after the lighting arrangements are selected, one can study the combined effect in the room from different perspectives. This is in fact a primary advantage of the virtual showroom. It can simulate the overall effect of the combination of lighting arrangements in all the areas of the room as realistically as possible so that the consumer can find the overall solution that best suits his needs.

There is also a “tips and tricks” feature (referred to hereinafter as “tips”) where much useful information on the lighting for the selected room can be found. Tips are available for each room with regard, for example, to wiring specifications, luxury aspects and energy saving. The tips are presented both in text and in graphics.

The virtual showroom also contains a glossary of light that provides clear explanations for more than 50 technical terms and phrases. Also, an introductory explanation is available about various topics involving indoor lighting to familiarize the consumer with the technical, psychological and physiological backgrounds in handling light and illumination.

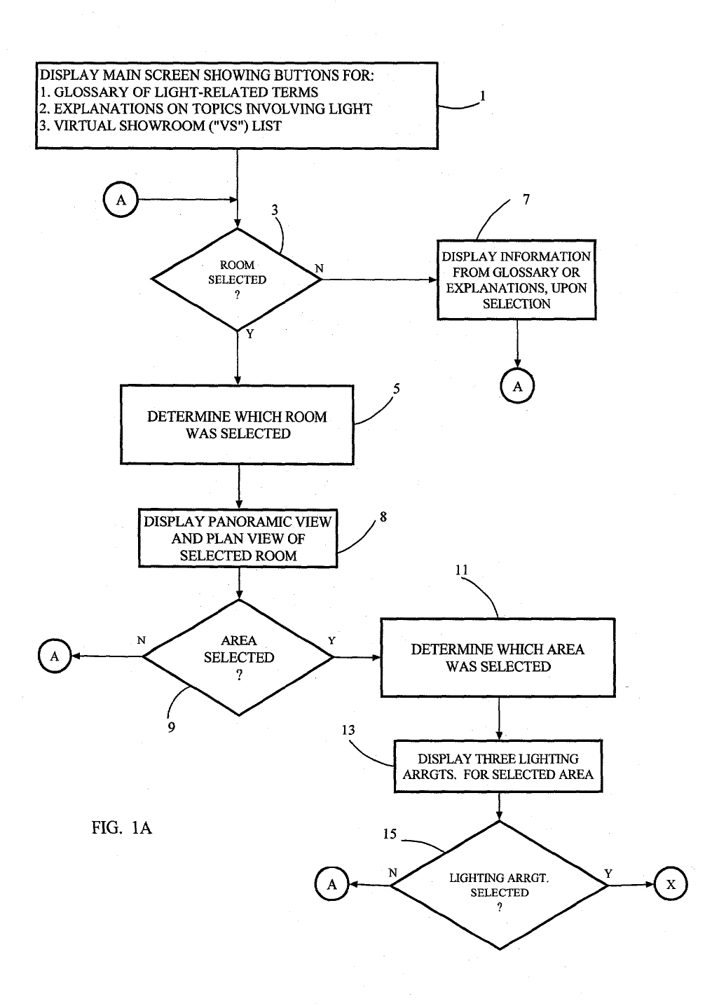

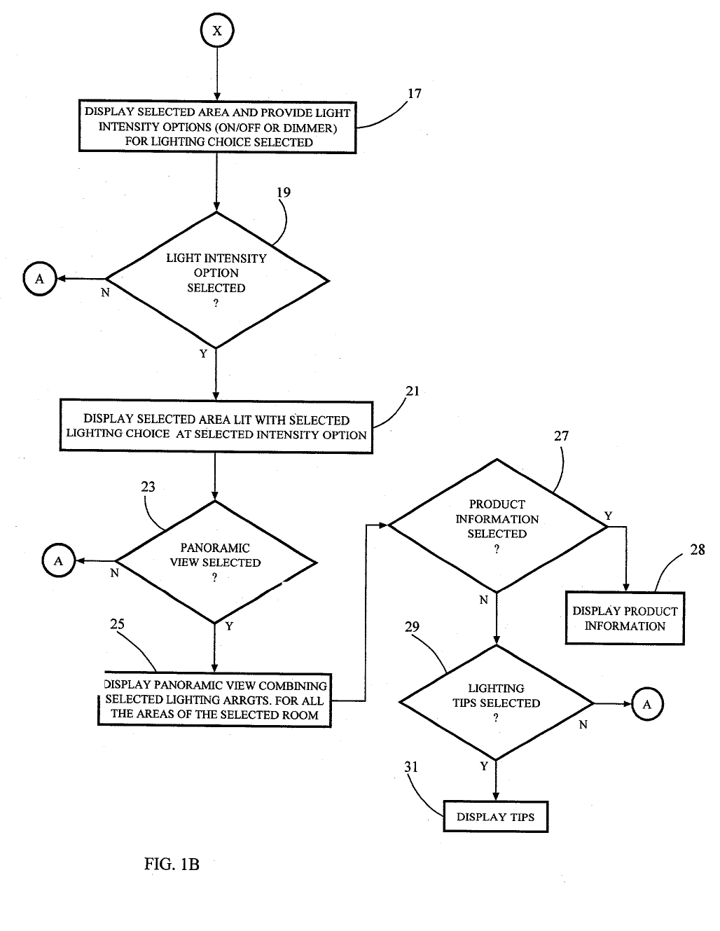

Turning now to FIG. 1A, when operation of the invention is initiated, such as by accessing the appropriate website, the consumer's computer screen displays various buttons that can be selected by, for example, the click of a mouse. As used herein, the term “buttons” refers to the actual display of a button-like icon as well as to hypertext. This is depicted by box 1 in that the consumer can select from among buttons that enable access to the above-mentioned glossary, explanations, and any one of the listed virtual showrooms. If a virtual showroom has been selected by clicking on the appropriate button, as determined by step 3, then step 5 determines which particular room has been selected. If decision box 3 determines that a virtual showroom has not been selected, then box 7 represents operations performed when a button has been clicked for either the glossary or the explanations and, if so, the display thereof. If none of the buttons has been selected, then the flow returns to point “A” in the flow chart above box 3.

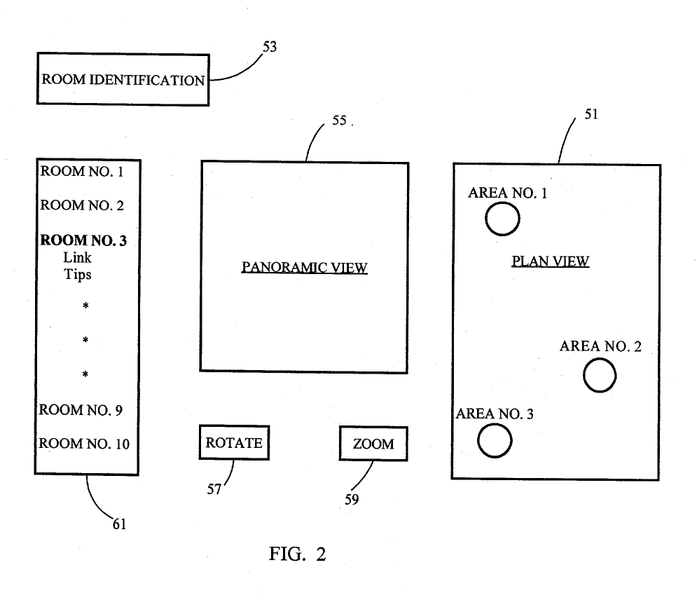

Once a particular room has been selected, as determined by step 5, step 8 generates on the computer screen a juxtaposed display of the panoramic view and plan view of the selected room. Such computer screen is depicted in FIG. 2. Turning now to FIG. 2, it shows a screen portion represented by box 51 which is a plan view of the selected room. The common name of the selected room is printed in box 53, such as “KITCHEN”, when a signal is generated by step 5 which identifies the selected room. Screen portion “51” identifies areas 1, 2 and 3. Even though FIG. 2 simply includes legends such as “AREA NO. 1”, in fact, this could be a specific term which labels that area. Thus, in a “KITCHEN” the “AREA NO. 1” could be replaced with “WORKING AREA”.

As screen portion 51 depicts a plan view of the selected room, simultaneously screen portion 55 depicts a panoramic view of the selected room. This view is continuously rotating to simulate a video camera positioned in the center of the room, being continuously swivelled through 360°. The rotation can be stopped at any point by left-clicking the mouse with the cursor positioned on the panoramic view. Rotation can be continued manually by positioning the cursor in box 55 and moving it while holding down the left button on the mouse. The same effect can also be achieved by using keyboard keys that are identified in box 57, labeled as “ROTATE” in FIG. 2. However, it will be understood that box 57 can show the particular keyboard keys that must be actuated to achieve the rotation function, such as the four cursor keys. Box 59 enables a zoom operation to be performed on the panoramic view. The zoom can also be performed with the mouse and/or keyboard keys in a well-known manner, details of which are not deemed necessary.

Screen area 61 shows a listing of the various rooms available in the virtual showroom function. Each of these rooms can be clicked on at any time to switch the screen shown in FIG. 2 from the currently selected room to a different one. The rooms are identified by number in box 61 but, of course, they would actually be identified by name. Thus, “ROOM NO. 3” shown in bold has been selected and, continuing with the example referred to above, for actual use of the invention it is labeled the KITCHEN.

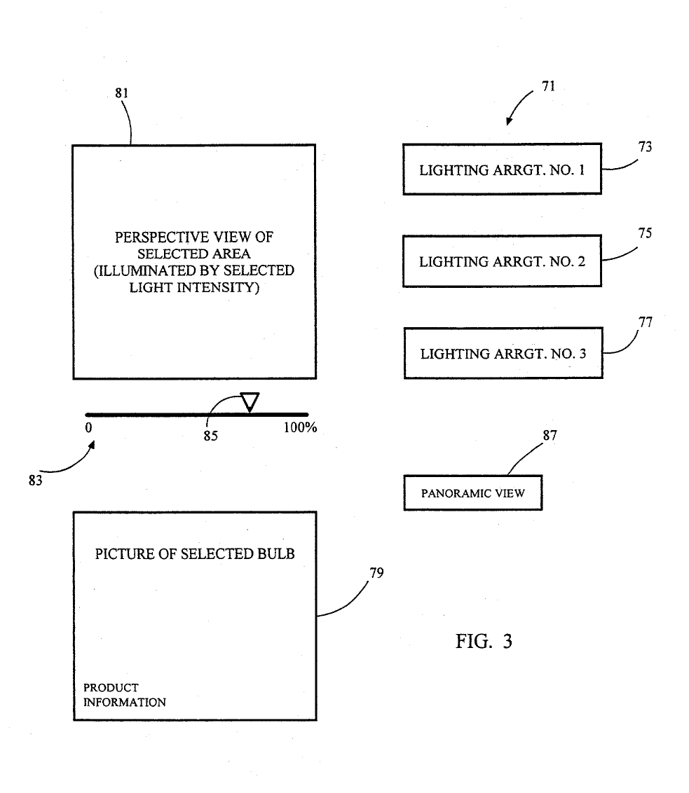

When “ROOM NO. 3” is clicked, it is bolded and menu buttons “Link” and “Tips” appear. By clicking on “Link” this activates most of the steps described herein with respect to FIGS. 2 and 3. When “Tips” is clicked, it diverts the display to steps 29 and 31, as discussed below.

The consumer can use the screen depicted in FIG. 2 to select one of the three areas shown in screen portion 51 by clicking on the area of interest. If an area is selected, as determined by step 9, the identity of the selected area is determined, per step. 11. When the identity of the selected area is determined, step 13 generates a screen which is depicted in FIG. 3.

Turning now to FIG. 3, it shows screen portion 71 with boxes 73, 75 and 77 that show, respectively, lighting arrangements 1, 2 and 3 that can be picked for the selected area. Each lighting arrangement includes a particular bulb and a fixture therefor. Thus, for example, for the eating area of a “KITCHEN”, lighting arrangement number 1 specifies a “suspended luminaire” with a “HALOPEN” bulb. Lighting arrangement number 2 specifies a ceiling-mounted down light with an “OSRAM DECOSTAR IRC” bulb. Lighting arrangement 3 specifies indirect lighting, with a “LUMILUX COMBI-N” electronic bulb. In addition to the fixture and the bulb that are set forth in each of areas 73, 75 and 77, each of these can also include a short descriptive text of the lighting produced by that lighting arrangement. Thus, for lighting arrangement number 1, the descriptive text could be “attractive halogen light for the eating place without additional ballast”.

When one of the lighting arrangements is selected, as the consumer clicks on it, screen portion 79 shows a picture of the particular bulb in that lighting arrangement. As picture 79 is displayed, screen portion 81 will show a perspective view of the selected area lit by the selected lighting arrangement. Initially, when the perspective view is first generated in screen portion 81, the amount of illumination is very low. Thus, in screen portion 83, which shows a scale of lighting intensity varying from 0 to 100%, pointer 85 will be initially at the 0 end. The consumer can increase the lighting intensity by moving pointer 85 to any desired point along the scale. This can be done in conventional fashion by clicking on the scale or “dragging” the pointer with the mouse. As pointer 85 is moved along the scale, screen portion 81 depicts a corresponding variation in the lighting intensity of the area. Thus, the consumer is given a simulated, but as realistic as possible, view of the effect produced by the selected lighting arrangement on the area. The consumer can similarly view the effect produced by any of the other three available lighting arrangements provided for that particular area of the selected room for the sake of making a comparison.

Screen portion 79 also contains a “PRODUCT INFORMATION” button that can be clicked on by the consumer at any time as per steps 27 and 28 in FIG. 1B. Details of the kind of information that this makes available to the consumer are discussed below.

Continuing with the description of FIG. 1A, step 15 depicts a determination that one of the lighting arrangements shown in screen portion 71 has been selected. When such a lighting arrangement has been selected, step 17 in FIG. 1B depicts the display of the perspective view of the selected area, as shown in the above-discussed screen portion 81. Also, step 17 generates the sliding scale in screen portion 83. In addition to the sliding scale as shown in FIG. 3, another possible light intensity option appropriate for some bulbs is an on/off switch. It will be understood that some bulbs are not dimmable, but, rather can only be turned on and off. Thus, instead of the sliding scale, screen portion 83 will show two buttons, for example, that are labeled “ON” and “OFF.” Step 19 determines the light intensity option that has been selected. More specifically, in the case of an on/off switch, step 19 will determine when the “ON” button has been clicked. Likewise, in the case of a sliding scale, step 19 will determine the point on that scale that has been selected by the consumer. Step 21 then proceeds to illuminate screen portion 81 in accordance with the light intensity selected by the consumer.

Thus, up to this point, the invention has enabled the consumer to select a particular room from several available choices, and then to select one of three areas in that room. In addition, for the selected area, three available lighting arrangements are proposed to the consumer. The consumer can select any one of these three lighting arrangements, the light intensity can be set, and the effect of that particular lighting arrangement on this specific area selected by the consumer can be viewed and compared with the other available choices.

In accordance with a particularly advantageous aspect of the present invention, all of the lighting arrangement choices made by the consumer for the three areas of a room can be combined by clicking on the button 87 in FIG. 3, labeled “PANORAMIC VIEW”. When this occurs, as determined by step 23 in FIG. 1B, the computer screen switches from that shown in FIG. 3 back to the one shown in FIG. 2. It should be mentioned that in the first display of the panoramic view for a selected room, as per step 8, the illumination is based on a default selection of the lighting arrangement for each of the room areas. This time, however, rather than the default lighting arrangements, the panoramic view of step 25 displays the illumination effect created by the combined lighting arrangements, at full light intensity, selected by the consumer for each of the room areas.

Decision box 27 is a determination of whether the product information button has been clicked in screen portion 79 of FIG. 3. If it has, then a new screen will be displayed with a page from the manufacturer's catalog for that particular bulb. The product information presented on that page includes range, wattages, order numbers, dimensions and the like. Likewise, decision box 29 determines whether the Tips button (as shown in FIG. 2) has been clicked. If so, the tips for the selected room will be displayed, per step 31.

Various other features can be added to those described above. For example, consumers can be given access to an extensive database of specialized dealers where all products of a particular manufacturer can be bought, and even further support is provided.

Also, a storage function can be provided to collect information in the form of text and image corresponding to selections made by the consumer as well as other information that has been accessed in the course of proceeding through the above-described steps of the invention. The information is stored and, if desired, printed.

Of course, the specific number of virtual showrooms, the number of areas in each room, and the number of lighting arrangements in each area is a matter of engineering choice and each could be readily increased or decreased. Also, the panoramic view could show the combined effect of all the selected lighting arrangements, with each being set to a desired light intensity rather than being at full intensity.

All of these and other such variations are intended to fall within the scope of the present invention as defined by the following claims.

We claim:

1. A computerized method to facilitate design by a consumer of a lighting plan for illuminating a room, comprising:
(a) providing an electronic display of the room showing a plurality of areas thereof;
(b) enabling selection by the consumer of any one from among said plurality of areas;
(c) enabling selection by the consumer of any one from among a plurality of lighting arrangements available for illuminating the selected area;
(d) enabling repetition by the consumer of steps (b) and (c) until a lighting arrangement has been selected for all of said plurality of areas; and
(e) displaying said plurality of areas respectively illuminated by said selected lighting arrangements, so that the consumer can decide whether the selected lighting arrangements, constituting the lighting plan for the room, are satisfactory.

2. The method of claim 1, wherein the lighting arrangement selecting step (c) comprises individually displaying each of the plurality of areas illuminated by the lighting arrangement selected therefor.

3. The method of claim 2, wherein the step of individually displaying each of the plurality of areas illuminated by the lighting arrangement selected therefor displays a perspective view of the selected area.

4. The method of claim 2, wherein the step of individually displaying each of the plurality of areas illuminated by the lighting arrangement selected therefor comprises enabling control by the consumer of lighting intensity produced with the selected lighting arrangement.

5. The method of claim 4, wherein control of the lighting intensity is with a selection between ON and OFF.

6. The method of claim 4, wherein control of the lighting intensity is with a gradually variable light controller.

7. The method of claim 1, wherein the displaying step (e) comprises displaying the room illuminated by the combined effect of illuminating all of the plurality of areas with the lighting arrangement respectively selected therefor, whereby the overall effect of the combination of lighting arrangements in all the areas of the room is simulated as realistically as possible so that the consumer can find the best lighting plan.

8. The method of claim 7, wherein the illuminated room displaying step (e) comprises displaying a panoramic view of the room.

9. The method of claim 8, wherein the panoramic view provides a rotating view of the room.

10. The method of claim 9, wherein the panoramic view is a continuously rotating view.

11. The method of claim 9, wherein the panoramic view is manually controllable to adjust at least one of rotational view angle and image zoom.

12. The method of claim 1, further comprising displaying a bulb that is included in the selected lighting arrangement.

13. The method of claim 1, further comprising enabling access by the consumer to product information about the selected lighting arrangement.

14. The method of claim 1, wherein the area selection step (b) comprises displaying a plan view of the room.

15. The method of claim 14, wherein the area selection step (b) comprises displaying in said plan view all of said plurality of areas.

16. The method of claim 14, wherein the area selection step (b) comprises displaying a panoramic view of the room juxtaposed with said plan view.

17. The method of claim 16, wherein a lighting plan of default lighting arrangements respectively illuminate the areas of the room in said panoramic view.

18. The method of claim 1, further comprising the step of enabling selection by the consumer of any one room from a plurality of rooms.

19. The method of claim 1, wherein step (c) comprises displaying identifying information for the plurality of lighting arrangements.

20. The method of claim 19, wherein each of said lighting arrangements comprises a bulb.

21. The method of claim 20, wherein each of said lighting arrangements further comprises a fixture for said bulb.

22. Apparatus to facilitate design by a consumer of a lighting plan for illuminating a room, comprising:
(a) means for providing an electronic display of the room showing a plurality of areas thereof;
(b) means for enabling selection by the consumer of any one from among said plurality of areas;
(c) means for enabling selection by the consumer of any one from among a plurality of lighting arrangements available for illuminating the selected area;
(d) means for enabling repetition by the consumer of steps (b) and (c) until a lighting arrangement has been selected for all of said plurality of areas; and
(e) means for displaying said plurality of areas respectively illuminated by said selected lighting arrangements, so that the consumer can decide whether the selected lighting arrangements, constituting the lighting plan for the room, are satisfactory.

23. The apparatus of claim 22, wherein the lighting arrangement selecting means (c) comprises means for individually displaying each of the plurality of areas illuminated by the lighting arrangement selected therefor.

24. The apparatus of claim 22, wherein the displaying means (e) comprises means for displaying the room illuminated by the combined effect of illuminating all of the plurality of areas with the lighting arrangement respectively selected therefor, whereby the overall effect of the combination of lighting arrangements in all the areas of the room is simulated as realistically as possible so that the consumer can find the best lighting plan.

25. The apparatus of claim 24, wherein the illuminated room displaying means (e) comprises means for displaying a panoramic view of the room.

26. The apparatus of claim 22, wherein the area selection means (b) comprises means for displaying a plan view of the room.

27. The apparatus of claim 22, further comprising means for enabling selection by the consumer of any one room from a plurality of rooms.

28. An article of manufacture for use in a computer system to facilitate design by a consumer of a lighting plan for illuminating a room, and having a computer readable code means for:
(a) providing an electronic display of the room showing a plurality of areas thereof;
(b) enabling selection by the consumer of any one from among said plurality of areas;
(c) enabling selection by the consumer of any one from among a plurality of lighting arrangements available for illuminating the selected area;
(d) enabling repetition by the consumer of steps (b) and (c) until a lighting arrangement has been selected for all of said plurality of areas; and
(e) displaying said plurality of areas respectively illuminated by said selected lighting arrangements, so that the consumer can decide whether the selected lighting arrangements, constituting the lighting plan for the room, are satisfactory.

29. A computer data signal embodied in a carrier wave, for use to facilitate design by a consumer of a lighting plan for illuminating a room, comprising:
(a) a first code segment for providing an electronic display of a room showing a plurality of areas thereof;
(b) a second code segment for enabling selection by the consumer of any one from among said plurality of areas;
(c) a third code segment for enabling selection by the consumer of any one from among a plurality of lighting arrangements available for illuminating the selected area;
(d) a fourth code segment for enabling repetition by the consumer of steps (b) and (c) until a lighting arrangement has been selected for all of said plurality of areas; and
(e) a fifth code segment for displaying said plurality of areas respectively illuminated by said selected lighting arrangements, so that the consumer can decide whether the selected lighting arrangements, constituting the lighting plan for the room, are satisfactory.
